(19) United States
(12) Patent Application Publication
(10) Pub. No.: US 2008/0056381 A1
(43) Pub. Date: Mar. 6, 2008

(54) Image compression and decompression with fast storage device accessing

(76) Inventors: Chih-Ta Star Sung, Glonn (DE); Yin-Chun Blue Lan, Wurih Township (TW); Bey-Yun Kuo, Banciao City (TW)

Correspondence Address: Chih-Ta Star SUNG, RM, 308, BLD. 52, NO. 195, CHUNG HSING RD., SEC. 4, JHU DONG TOWNSHIP, HSINCHU COUNTY, 310, omitted

(21) Appl. No.: 11/512,136

(22) Filed: Aug. 30, 2006

(51) Int. Cl. H04N 7/12

(52) U.S. Cl. 375/240.26

(57) ABSTRACT

An image compression method and fast storage device accessing and pixel decompression is achieved by asserting the starting location of one or more groups of compress pixels. Information of at least one upper line of pixel's pattern complexity is temporarily saved into a register for predicting the code length of the targeted pixel of the current line and deciding the coding method.

### BACKGROUND OF THE INVENTION

1. Field of Invention

The present invention relates to method and apparatus for reducing data rate of image pixels, and particularly relates to compression and decompression of an image frame with fast random accessing any pixels saved in the storage device.

2. Description of Related Art

The digital image and motion video have been adopted in an increasing number of applications, which include digital camera, scanner/printer/fax machine, video telephony, videoconferencing, 3G mobile phone, VCD (Video CD), DVD, digital TV . . . etc. The success of development of the digital image and video compression standards including JPEG, a still image compression standard set by ITU and the MPEG, the motion video compression standard set by the ISO have played key role for the digital image and video applications.

Both JPEG and MPEG are lossy algorithms which when being decompressed, the image data are different from the original ones. And the bit rate of each image frame is variable depending on the complexity of the image pattern.

In the LCD TV, LCD monitor, LCD Driver, DVD, STB, Set-Top-Box, 3G mobile phone or other portable devices like scanner/printer, a decompressed video stream of continuously image will be temporarily saved into a storage device for other manipulation including scaling and de-interlacing before being sent to a display device. In these kind of applications, a fixed bit rate of compressed image is expected for convenience of allocating fixed density of the storage device or/and allocating fixed bandwidth of accessing the storage device during a pre-scheduled time slot. Fixed bit rate of a compressed image frame provides necessary performance of random accessing pixels of any area with a fixed density of storage device which results in the saving of cost and power consumption. Since these image frames temporarily saved in the storage device will be used as references in the further image frames, keeping good quality is required for ensuring the good image quality for next image.

Therefore, it is beneficial to reduce the bit rate of an image frame with a predetermined fixed bit rate while still keeping good image quality for further image frames' reference. The capability of being quickly random accessed and decompressed pixels of any area of an image enhances the performance of other manipulation including image compensation, scaling, de-interlacing and displaying.

### SUMMARY OF THE INVENTION

The present invention is related to a method and apparatus of the image frame compression with fast memory accessing and reconstruction, which plays an important role in image data reduction for the image frame. The present invention significantly reduces required storage device density, on-chip image buffer and accessing bandwidth of the image within the storage device.

The present invention of the image frame compression takes the advantage of only little difference between adjacent lines and adjacent pixels and compresses the current frame group by group with each line of pixels having variable bit rate.
According to an embodiment of this invention, the bit rate of an image frame is fixed and each line of pixels is compressed with variable bit rate.
According to an embodiment of this invention, the bit rate information of each line is stored in a temporary buffer and sent to the memory followed by the compressed pixel data.
According to an embodiment of this invention, adjacent groups of pixels share one referencing pixel and the starting address indicates the location of the referencing pixel and can quickly access and recovers any pixels within the group.
According to an embodiment of this invention, a pixel with large difference to the neighboring pixels will be marked and the corresponding pixels in the next line will be examined to decide whether not go through the VLC coding.
According to an embodiment of this invention, a pixel takes differential values of the neighboring pixels in upper line and left pixel to predict the complexity of current pixel and to decide whether not go through the VLC coding of current pixel.
According to an embodiment of this invention, at least 2 lines of marker bits are implemented to save the location of pixels with complicated values as reference for the next line to decide which of the 3 the corresponding pixels beneath should not go through the VLC coding.
According to an embodiment of this invention, the address of starting pixel of each group/line is saved in a temporary buffer and sent to the memory and saved in a predetermined location with the memory for fast accessing and reconstructing any line of pixels.

According to an embodiment of the present invention, during random accessing any area, the starting location of the selected area within storage device is calculated firstly, and then, the pixels are decompressed in pipelining.

According to another embodiment of the present invention, the temporary buffer saved the address of starting address of each line of a predetermined amount of lines of pixels and being sent to the memory accompanied with a control signal to indicate the type of transferring data.

According to an embodiment of the present invention, the memory stores the compressed image data and the address of starting point separately in predetermined location.

It is to be understood that both the foregoing general description and the following detailed description are by examples, and are intended to provide further explanation of the invention as claimed.

### BRIEF DESCRIPTION OF THE DRAWINGS

FIG. 1 illustrates the prior art of image frame compression with constant bit rate of each line.

FIG. 2 illustrates an image frame compression with variable bit rate of each line/area and a predetermined frame bit rate.

FIG. 3 illustrates the compressed image data followed by the bit rate information and the address of starting point of each line of an image frame.

FIG. 4 shows the procedure of decoding the starting location with an image frame by calculating the bit rate of each line and the starting address of each group of lines.

FIG. 5A depicts a group of pixels sharing a referencing pixel.

FIG. 5B depicts an alternative of 2 sub-groups share one reference is optional if recovering speed is not critical to the application.

FIG. 6A illustrates the concept of identifying a worse pixel which has large differential value to adjacent pixel.

FIG. 6B illustrates the concept of identifying a worse pixel beneath with prediction by referring upper two lines pixels.

FIG. 7 illustrates the block diagram of how the compression engine saves the starting address of a group of lines into a temporary buffer and output the compressed data and starting address controlled by data or address “Ready” signals.

FIG. 8 illustrates how the signals and data/addr. bus which are interface to the memory.

FIG. 9 illustrates how the compressed image data and corresponding starting location of each area (or line) can be stored in the memory.

### DESCRIPTION OF THE PREFERRED EMBODIMENTS

Some display devices require high density of the storage device for temporarily saving the decompressed image(s) generated from an image source like an MEPG/JPEG decoder. Some storage devices so called “Frame Buffer” are used to save the image or video frames for periodically displaying the image to a display device. Some of the temporary storage devices (frame buffer) are used to save the image frame for quality enhancement manipulation including image scaling and de-interlacing. Especially the later, for achieving high quality, at least two previous image frames are temporarily saved for image compensation for reconstructing the current image frame. Fast accessing pixels of any area within an image frame becomes very challenging task which requires high I/O bandwidth between an image or video codec and the image frame storage devices.

This invention of the image frame compression of the image or video stream reduces the bit rate of the image frame by assigning a fixed bit rate of an image frame with the capability of fast random accessing and decompressing pixels of any region, for example, any line or any segment within a frame.

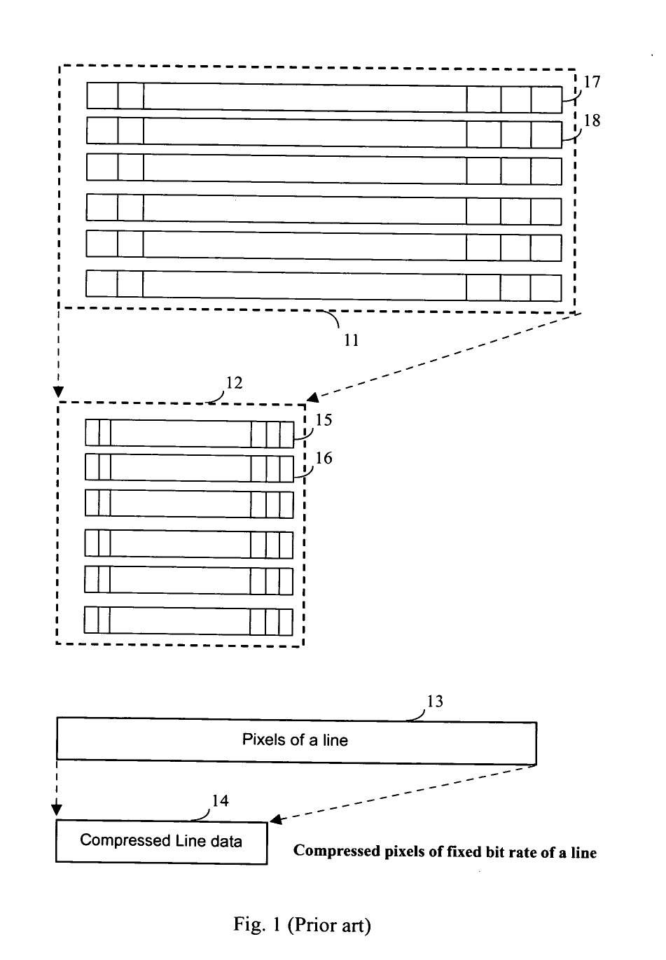

FIG. 1 illustrates a prior art of image compression. An image frame 11 is comprised of a certain numbers of lines of pixels 17, 18. In this prior art image compression, each line of pixels 13 is compressed with fixed bit rate 14, for example, a 2.0× compression rate and comes out of a fixed length of bits of each line 15, 16 and all compressed lines together form the compressed image with fixed bit rate 12. The advantage of this prior art image compression with fixed group or said line compression rate is that this scheme allows quickly accessing and decompressing any line of pixels. The disadvantage of this prior art of image frame compression is lack of flexibility of allowing more bits for lines with more complex pattern which might be difficult in compressing pixels to a predetermined bit rate.

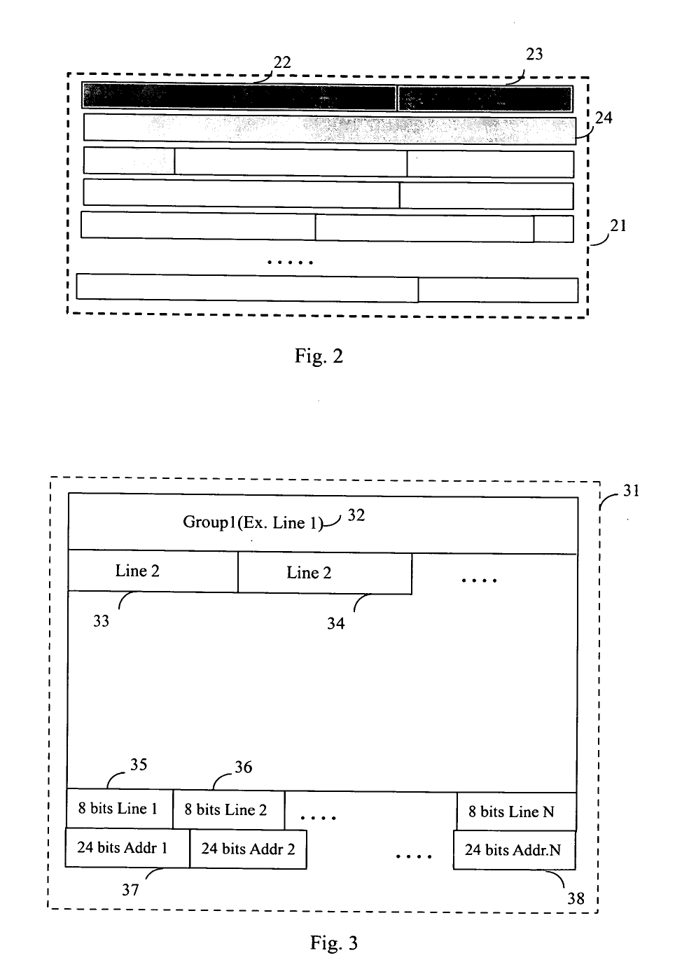

FIG. 2 shows a basic of another image compression method of this invention of image frame compression. Those lines with shorter bit rate 22, 23, are lines having simple patterns which save more bits and can be shared with the lines with more bit rate 24 with more complex patterns. Together, this variable length of bits of each line of compressed pixels forms a fixed bit rate of an image frame 21.

In prior art image frame compression shown in FIG. 1, the difficulty in compressing an image frame is the unpredictable bit rate allocation, hence and can only assign fixed number to each group/line. This invention of image frame compression takes advantage sharing bit numbers among groups of pixels with simple patterns and complex patterns. The compressed pixels data with variable bit rate of each group, for example, a line of pixels 32, 33, 34 are saved into a storage device. For accelerating the accessing and decompression speed, a predetermined counter is to calculate the bit rate of each group 35, 36 (for example a line of pixels) and to save it in the temporary register for recording and tracking the starting address in the storage device for each group of pixels. During accessing compressed pixels saved in the corresponding location, the pixel of the starting address 37, 38, 39 of a group of pixels will be extracted first and used as reference pixel for reconstructing the rest of pixels within the group.

For saving the hardware, a starting address of the storage device saving the compressed pixels can be shared by predetermined amount of groups (or said lines) of pixels. Each group of compressed pixels can have a predetermined length of code to represent the bit rate. For example, a segment as a group of 32 pixels with 16 bits per pixel, a 4 bits code 35, 36 represents 2 times compression (=256 bits) plus/minus one of (64, 32, 16, 8, 4, 2, 1) bits with predetermined definition. So, the code representing the relative length of each group saves some bits compared to the complete code representing the address of storage device which also save hardware in implementation. In some applications when a full address representing the location of each group of compressed pixels is not critical, the applying code to represent address of each location of group of pixels is applicable. The starting address will be saved into the predetermined location within the storage device which saves the compressed image data as well.

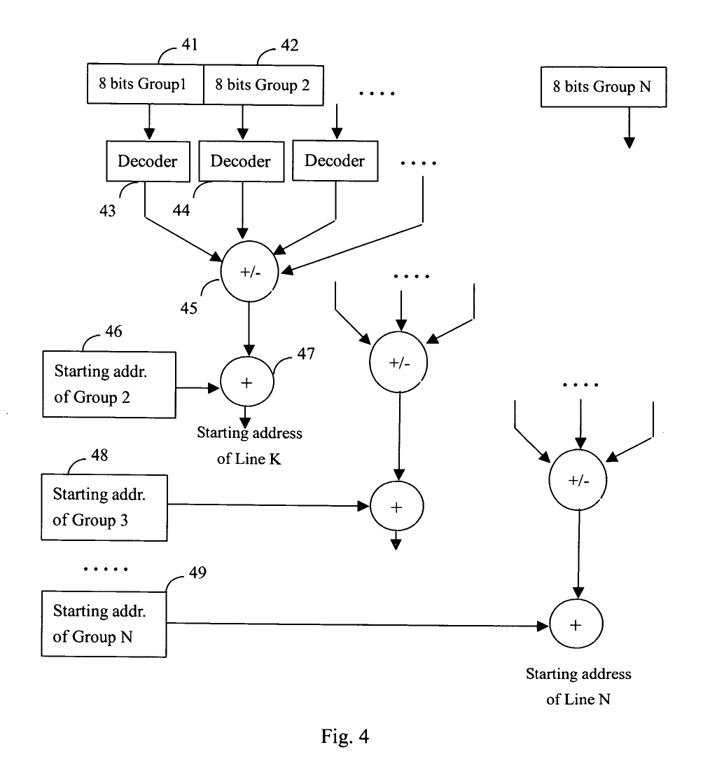

FIG. 4 illustrates the procedure of decoding the starting address of each group of the compressed pixels saved in the storage device. The bit rate decoders 43, 44 calculate 45 the length of each group 41, 42 of pixels and combines 47 with the starting address 46, 48, 49 of a cluster of groups of compressed pixels will come out of the exact location of the starting or said referencing pixel of a group of compressed pixels. In most hardware including IC implementation, it takes about 1 clock cycle of time to decode and calculate the starting location of any group of the compressed pixels and access the starting pixel for reference of other pixels.

Some applications will write only part of an image with decided location of a frame into the previous image being displayed in the display device. In this condition, the corresponding groups of compressed pixels will be quickly accessed and decompressed before new pixels are concatenated and form and new group before going through the compression procedure and being saved into the storage device.

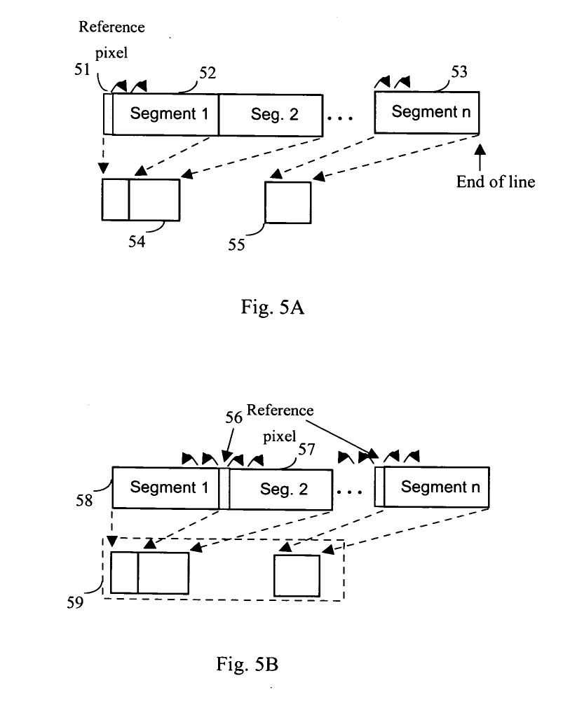

FIG. 5A depicts a method of this invention of compression with a couple of groups 52, 53 of pixels sharing one reference pixel 51. In most cases, the differential values of adjacent pixels are calculated first, following by an entropy coding method which most likely is a variable length coding. The compression is done group by group with variable length of each group of pixels 54, 55. Some mechanisms help accelerating the compression and decompression speed. FIG. 5B shows one of them. One referencing pixel 56 can be share by two neighboring groups 57, 59 of pixels. And every two compressed groups will have a referencing pixel inserted in between and eventually form the complete compressed image frame 59.

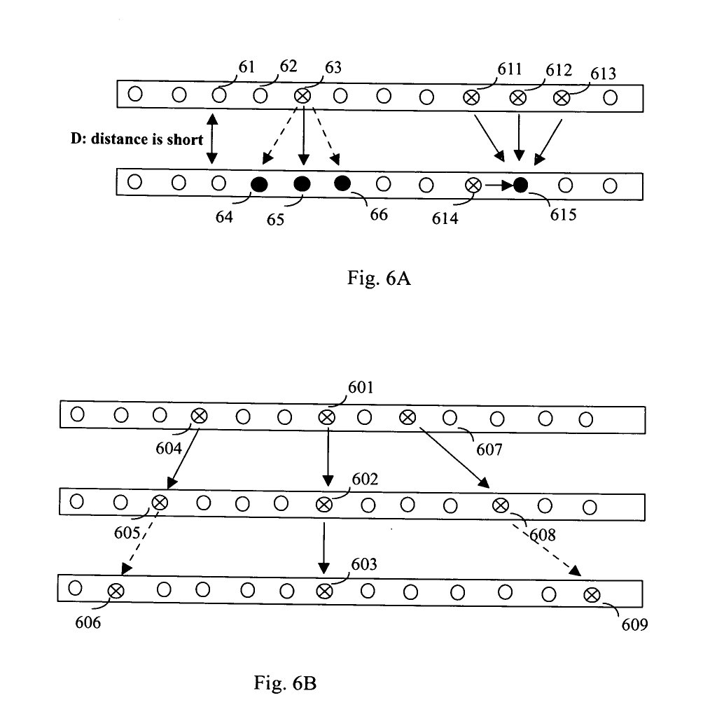

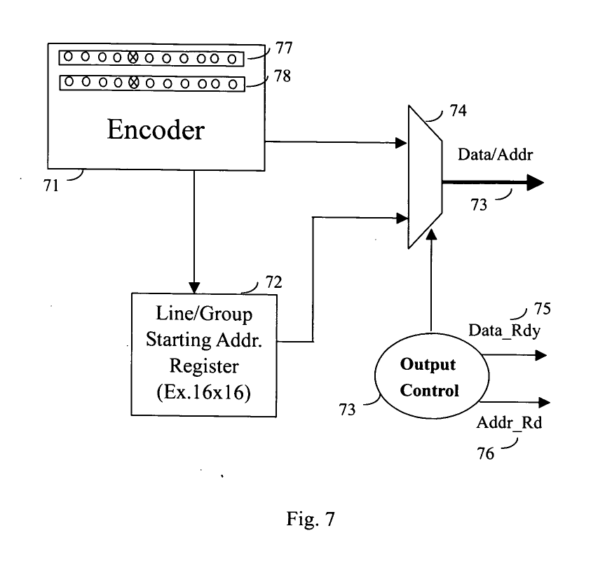

Taking advantage of little difference from pixel to adjacent pixel, the line to line correlation is leveraged in this invention. It is not uncommon in many lossless image compression algorithms that the pixel with large difference to the adjacent pixel will result in longer length of coding than without applying compression method. One of this invention of image frame compression is to apply a register bit to record the pixel as shorter (for example, a logic polarity of “0”) or longer (for example, a logic polarity of “1”) than a predetermined length after a variable coding. As depicted in FIG. 6A, most pixels 61, 62 require shorter code compared to represent the differential value except for very few pixels 63 which might be pixel by the edge of new object. Comparing to other pixels, the neighboring pixels 64, 65, 66 of the pixel being marked “1” in the line beneath have high probability of reaching longer code by applying variable length coding method which, therefore, the fixed length code of differential value, not a variable length code will be kept to represent the differential value. For most pixels of the edge of a new object, the continuity from line to line is similar to that of adjacent pixels. And the object edge can stretch vertically, horizontally or any degree in between. Another mode of predicting the pixel having larger value by applying variable length coding is to examine the surrounding pixels 611, 612, 613 in upper line and adjacent pixel 614. Statistically, the more surrounding pixels having larger differential values, the higher probability the current pixel will need longer code to represent the differential value. Taking three right top pixels of upper line and left pixel as references, a weighted average of these four surrounding pixels can be compared to the predetermined threshold to decide whether the current needs to avoid the variable length coding. A register is used to record pixel information as large or small differential value of at least one upper line and adjacent pixels of current line is also used to predict the complexity of current pixel by calculating the average number of the surrounding pixels in upper line and adjacent pixel. For example, if two or more of the four surrounding pixels have high differential values, the current pixel will not go through a variable length coding and will use the fixed code of differential value.

FIG. 6B depicts the method of this invention of more accurately predicting the pixels with longer than a predetermined length of code if a variable code by applying marker bits representing the ease or complexity of each pixel of the two upper lines. If the pixels of two upper lines form any linearity of the tone change, the current line pixels will have high probability of continuity of the momentum of tone change. For example, edge by vertical direction, 601, 602 of upper two line happened, the pixel of current line 603 right below is very likely a pixel of edge with larger differential value compared to the adjacent pixel to the left. Should the tone change is from around 45 degree from right to left pixel 604, 605 from two upper lines, the further left pixel 606 of current line will have high chance to be the edge with larger differential value compared to the adjacent pixel to the left. Should the tone change is from around −30 degree from left pixel to right pixel 607, 608 from two upper lines, the further right pixel 609 of current line will have high chance to be the edge with larger differential value compared to the adjacent pixel to the left. This invention of upper lines edge tracking and current line edge prediction has high probability of accurately identifying the edge and applying fixed code which is very likely shorter than most variable length coding.

For storage device to be easier in saving the compressed pixels' data and starting address of identifying each group of compressed pixels, the compressed data and starting address are saved in predetermined different location. In an implementing the hardware of compressing the image frame, a compression engine 71 with register recording the ease or complexity of each pixel of two upper lines 77, 78 are combined with a register temporary saving the starting address 72 of group of pixels. The starting address and the compressed pixel data can share the same output bus 73 with a MUX 74 as a output selector or separately output to the targeted storage device. A control unit 73 generates the selection signal as well as sending out two enable signals 75. 76 to indicate the availability of compressed pixel data or starting address. With the valid data on the data/addr bus along with the “Data-Rdy” (data ready) or “Addr-Rdy” (Address ready) signals, the storage device will save the data or address in separate location without confusion.

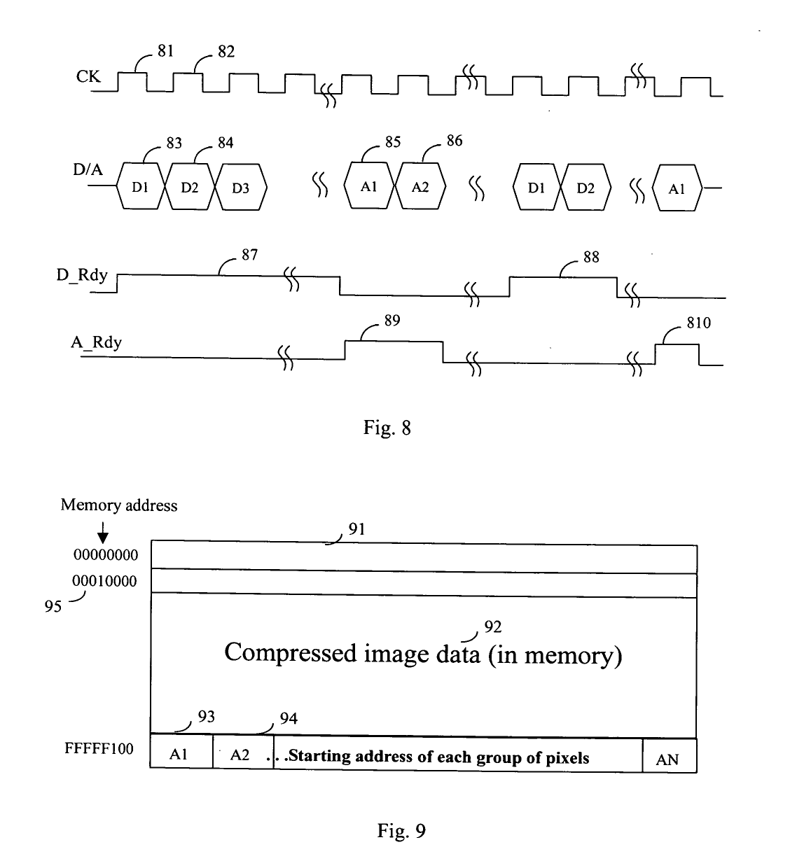

FIG. 8 shows the timing diagram of the handshaking of the data-addr and control signals of the compression engine. The valid data 83. 84 or address 85, 86 are output by most likely a burst mode with D-Rdy (data valid) 87, 88 and A-(Address valid) 89, 810 signals with active high enabling. All signals and data are synchronized with the clock 81, 82. With this kind of handshaking mechanism, the storage device will clearly understand the type and timing of the valid data and starting address of the groups of pixels. The temporary register saving the starting address can be overwritten after the stored address information is sent out and no longer needed. By scheduling outputting the starting address and overwriting the register by new starting address of new groups of compressed pixels, the density of the temporary register can be minimized.

FIG. 9 shows an example of how the storage device saved the compressed image data 91, 92 and starting address 93, 94 of group by group. The storage device is most likely organized with predetermined code length of the mapping address 95. The starting address of a group or multiple groups of compressed pixels can be accessed first and be decoded to calculate the exact location of further line of pixels and accessing the compressed pixel data accordingly. By adopting this kind of mechanism of storing compressed data and starting address in a separate location within the targeted storage device, The time required to access, the time required to obtain the first pixel and further data of compressed pixels can eb as less as 2 clock cycles and decompression procedure can be done in parallel manner making fast accessing any location and recovering any pixel feasible.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of compressing an image frame and saving it to the storage device for fast accessing and decompression, comprising:
compressing the image frame pixels group by group with at least 2 groups of pixels having different compressed bit rates;
calculating the bit rate of each compressed group of pixels and converting to the corresponding address of the storage device;
saving the address of the starting location of at least one compressed group of pixels into the storage devices; and
when decompressing the targeted pixels, decoding the starting address of the corresponding group of pixels followed by accessing the referencing pixel and decompressing other pixels within the group.

2. The method of claim 1, wherein at least two registers are used to save the starting location of the storage device which saves at least two groups of the compressed image data and the register will be overwritten when the content have been sent and saved into the storage device.

3. The method of claim 1, wherein during saving the bit rate of each group of compressed pixels, a predetermined code length is assigned to represent the bit rate of a group of the compressed pixels.

4. The method of claim 3, wherein in the decoding the starting location of a group of compressed pixels, the starting location of a several of groups and the decoded numbers of a predetermined number of groups of pixels will be added to determine the exact location of the storage device which saves the compressed pixels.

5. The method of claim 1, wherein at least a group of pixels share one referencing pixel which is saved in a predetermined location of the storage device with a code representing the location.

6. The method of claim 1, wherein during accessing a line of compressed pixels, the starting location is accessed firstly, followed by the accessing the codes representing length of the groups of compressed pixels and the final location of the referencing pixel saved in the storage device can be calculated accordingly.

7. The method of claim 1, wherein the compressed pixels data are saved into the storage device in a predetermined location while the starting addresses of groups of compressed pixels are saved in another location of the storage device.

8. A method of compressing an image frame, comprising:
compressing the pixels, group by group by firstly calculating the differential value of the pixel to the adjacent pixel;
recording information of each pixel of at least one line which have bit rate exceeding a predetermined threshold if coded by a selected variable length coding;
taking neighboring pixels of upper line and adjacent pixel as reference to predict and determine whether targeted pixel will go through a variable length coding or uses a fixed code to represent the differential value.

9. The method of claim 8, wherein a register is used to record at least one upper line pixels' information about whether the pixel's differential value is smaller or larger than a predetermined threshold.

10. The method of claim 8, wherein calculating the upper two lines of pixels' tone change and predicting whether or not the targeted pixel goes through a variable length coding or uses a fixed length coding to represent the differential value to the adjacent pixel.

11. The method of claim 8, wherein examining the information of the surrounding pixels including at least two pixels in upper line and one in current line to decide whether the targeted pixel goes through a variable length coding or uses a fixed length coding to represent the differential value to the adjacent pixel.

12. The method of claim 8, wherein calculating the differential value between adjacent pixels, there will be one pixel being used as the reference and starting pixel of one group of pixels.

13. The method of claim 8, wherein calculating the differential value between adjacent pixels, there will be one pixel being used as referencing pixel of two adjacent groups of pixels.

14. The method of claim 8, wherein in predicting the targeted pixel, if majority of the upper line pixels and adjacent pixels have been previously coded by a fixed length coding, then the targeted pixel will be coded by fixed length coding.

15. An apparatus for compressing an image frame with fast random accessing and decompressing any area of pixels within the compressed image frame, comprising:
a compression unit reduces the data rate of pixels group by group by referring to the bit rate information of the corresponding area of at least one upper line and saving the compressed pixel data into a temporary register for predicting the coding mode of the targeted pixel;
another circuitry calculating bit rate and saving the corresponding starting location of each group of pixels which are to be sent into a storage device;
a controller driving out at least two signals indicating which output data is compressed data and which is the location of the starting address of a group of pixels; and
a storage device saving the compressed pixel into the predetermined location and the location of starting address of at least one group of pixels into another location.

16. The apparatus of claim 15, wherein compressed pixel data and the starting address of groups of pixels can share the same bus with enabling signals to indicate under which timing, the bus signals are data or address.

17. The apparatus of claim 15, wherein the temporary register within the compression engine recording each pixel information of at least one line indicating whether the pixel is coded by a variable length coding or a fixed length of the differential value code.

18. The apparatus of claim 15, wherein the temporary register saving the starting address of groups of compressed pixels can be overwritten by new starting address once the starting address are output to the storage device.

19. The apparatus of claim 15, wherein the storage device saves the compressed pixel data into a predetermined location with burst mode of data transferring mechanism and saves the starting address of groups of pixels into another location with the control signals indicating which cycle time has compressed pixel data or starting address on the bus.

20. The apparatus of claim 15, wherein the controller outputs at least two signals, one indicating “Data ready” another for “Starting address ready” coupled with a output data selection signal.
